(19) United States
(12) Patent Application Publication
(10) Pub. No.: US 2016/0208846 A1
(43) Pub. Date: Jul. 21, 2016

(54) OUTER CASING FOR CONTROL CABLE, AND CONTROL CABLE

(71) Applicant: NHK SPRING CO., LTD., Yokohama-shi, Kanagawa (JP)

(72) Inventors: Akihiko Kitazawa, Ina-shi (JP); Iroku Suzuki, Ina-shi (JP); Kouichi Kusakawa, Yokohama-shi (JP)

(73) Assignee: NHK SPRING CO., LTD., Yokohama-shi, Kanagawa (JP)

(21) Appl. No.: 14/915,005

(22) PCT Filed: Aug. 8, 2014
(86) PCT No.: PCT/JP2014/071093

§ 371 Date: Feb. 26, 2016

(30) Foreign Application Priority Data
Aug. 28, 2013 (JP) 2013-177002

(51) Int. Cl. F16C 1/26

(52) U.S. Cl. CPC F16C 1/267; F16C 1/26

(57) ABSTRACT

An outer casing for a control cable 10 has an inner tube 12, which includes a resin tube having a tubular resin layer and two metal wires buried, in the resin layer of the resin tube, in parallel with an axial direction and at positions symmetrical with each other about an axis of the resin tube, in which when an outer diameter of the resin tube is D (mm) and a distance between the two metal wires is A (mm), the following formulae (1) and (2) are satisfied.

1.5≦D≦4 (1)

0.5 D≦A≦0.7 D (2)

### TECHNICAL FIELD

The present invention relates to an outer casing for a control cable used in vehicles or the like, and also relates to a control cable.

### BACKGROUND ART

A typical control cable is formed by a flexible pipe-shaped outer casing and an inner cable made of a metal wire, with the inner cable being inserted through the outer casing. The control cable has a remote control function by pushing, pulling, or rotating one end of the inner cable to realize remote control of a passive type device disposed at the other end of the inner cable. For example, the control cable may be used in a vehicle for various purposes, such as an open/close cable for a sunroof, an open/close cable for windows, or a cable for the parking brake.

For an outer casing of the control cable, dimensional stability in a longitudinal direction is strictly required. Since the inner cable is a metal wire, a linear expansion coefficient and a compression characteristic equivalent to those of the metal wire are required.

If thermal expansion of the outer casing is large, the inner cable acts as if pulled even when the inner cable is not operated. This may cause a malfunction such as failure to close an oil supply port. If the outer casing is soft, the length of the outer casing may be compressed and shortened by operation of the inner cable. In such a case, the control cable may be inoperable even when the inner cable is pulled.

Such things can be confirmed by measuring a thermal expansion and a stroke loss (play of the inner cable that causes malfunction if it is too large) of resin in the outer casing. Specifically, stroke loss is measured by measuring stroke values relative to a load acted on the inner cable by changing temperatures. A smaller value of stroke loss is preferable.

The outer casing made of resin tends to generate problems as described above. A tubular body, therefore, that is formed by tightly winding a flat steel wire around the outer periphery of an inner tube (liner) made of resin in a spiral manner, with the outer side of the tubular body further covered by resin has conventionally been used (see Japanese Patent Application Laid-Open No. 2002-286017, for example).

However, such an outer casing around which the flat steel wire is spirally and tightly wound is heavy, and does not satisfy lightweight requirement in the recent trend of electric vehicles or hybrid vehicles.

Meanwhile, an outer casing in which a metal wire is linearly buried in a resin layer has been proposed (see JP-A Nos. S47-11410, S59-16726, and 2011-99524, and Japanese Utility Model Application Laid-Open No. S59-22322, for example).

For example, an outer casing for a control cable in which a reinforcing wire, in which flat portions are formed by pressing a metal tube at appropriate intervals, is buried in parallel with an axial center of the casing body in the thickness of the tubular casing body made of synthetic resin has been proposed (see JP-U No. S59-22322).

A method of manufacturing an outer casing by introducing a metal wire into an extruder and burying the metal wire in a thickness part of the tubular conduit made of resin has also been proposed (see JP-A No. S59-16726, for example).

A control cable used in a drain plug remote operation apparatus, which has an outer casing including two metal wires buried in a cylindrical body made of polyolefin-based thermoplastic elastomer in parallel with the axis of the body and opposing from each other by 180 degrees about the axis has also been proposed (see JP-A 2011-99524).

### SUMMARY OF INVENTION

### Technical Problem

When an outer casing for a control cable is configured to include two metal wires buried, in the thickness of the cylindrical resin layer, in parallel with each other in the longitudinal direction thereof, the outer casing is easily bent at right angles relative to a plane including the two metal wires, but is extremely difficult to bend toward the inside of the plane including the two metal wires. Thus, the outer casing has unfavorable routing properties. In addition, if the wire is routed forcibly, breaking of the metal wires, breakage of the resin layer, or the like, may occur. Thus, an outer casing has not been widely used.

It is an object of the invention to provide an outer casing for a control cable, which is lightweight and can be routed easily, and also to provide such a control cable.

### Solution to Problem

To achieve the above object, the invention is provided as described below.

A first aspect of the present invention is an outer casing for a control cable, the outer casing including a resin tube which has a tubular resin layer, and two metal wires which are buried, in the resin layer of the resin tube, in parallel with an axial direction of, and at positions symmetrical with each other about the axis of the resin tube, and when it is assumed that an outer diameter of the resin tube is D (mm) and a distance between the two metal wires is A (mm), the following formulae (1) and (2) are satisfied.

1.5≦D≦4 (1)

0.5 D≦A≦0.7 D (2)

A second aspect of the invention is the outer casing for a control cable according to the first aspect, in which the resin layer of the resin tube includes a crystalline resin.

A third aspect of the invention is the outer casing for a control cable according to the second aspect, in which a storage modulus of the crystalline resin is from 950 to 3,000 MPa.

A fourth aspect of the invention is the outer casing for a control cable according to the first aspect, in which the resin tube includes an outer tube, which includes the two metal wires buried therein, and an inner tube, which is layered inside of the outer tube and includes a crystalline resin.

A fifth aspect of the invention is the outer casing for a control cable according to the fourth aspect, in which the outer tube includes a thermoplastic elastomer or soft vinyl chloride.

A sixth aspect of the present invention is a control cable which includes the outer casing for a control cable according to any one of the first to fifth aspects, and an inner cable inserted in the outer casing for a control cable.

### Advantageous Effects of Invention

According to the first aspect of the invention, an outer casing for a control cable, which is lightweight and easy to route, is provided.

According to the second aspect of the invention, an outer casing for a control cable that achieves both slidability and routing properties is provided.

According to the third aspect of the invention, an outer casing for a control cable that restricts protrusion of the metal wire from the resin layer is provided.

According to the fourth aspect of the invention, an outer casing for a control cable is provided that achieves both slidability and routing properties and is also easily manufactured.

According to the fifth aspect of the invention, an outer casing for a control cable that achieves further improvement of the routing properties is provided.

According to the six aspect of the invention, a control cable that is lightweight and easy to route is provided.

### BRIEF DESCRIPTION OF DRAWINGS

FIG. 1 is a schematic view showing an exemplary structure of an outer casing for a control cable of the present invention.

FIG. 2 is a schematic view showing a cross-section perpendicular to the axial direction of the outer casing for the control cable shown in FIG. 1.

FIG. 3 is a schematic view showing another exemplary structure of an outer casing for a control cable of the present invention.

FIG. 4 is a schematic view showing a step of forming an outer tube around an outer periphery of an inner tube during manufacturing of an outer casing for a control cable of the present invention.

FIG. 5 is a schematic view for explaining how stroke loss is measured.

FIG. 6 is a schematic view for explaining how load efficiency is measured.

FIG. 7 is a graph showing a relationship between a load and a deflection amount when routing load of the outer casing is measured in the Examples and the Comparative Example.

FIG. 8 is a schematic view showing how routing load of the outer casing is measured in the Examples and the Comparative Examples.

FIG. 9 is a graph plotting a routing load of the outer casing relative to a distance between the metal wires in the Examples and the Comparative Examples.

### DESCRIPTION OF EMBODIMENTS

An outer casing for a control cable (which may simply be referred to as an “outer casing”) and a control cable according to the invention will be described in detail below by referring to the accompanying drawings.

<Outer Casing for Control Cable>

Inventors of the present invention have conducted research to solve a problem whereby an outer casing, in which two metal wires are buried in parallel with the axial direction of a resin tube, has directivity with respect to ease of bending. As a result, it has been found that lightness of weight and a rapid reduction of the routing load are realized under the conditions that the outer diameter D of the resin tube is from 1.5 to 4 mm and a distance A between the two metal wires (distance between the metal wires) buried in the resin layer is from 0.75 to 2.8 mm and within a range from 50 to 70% of the outer diameter D of the resin tube.

Namely, an outer casing for a control cable according to the present invention includes a resin tube which has a tubular resin layer, and two metal wires which are buried, in the resin layer of the resin tube, in parallel with an axial direction and at positions symmetrical with each other about the axis of the resin tube, and when it is assumed that an outer diameter of the resin tube is D (mm) and a distance between the two metal wires is A (mm), the following formulae (1) and (2) are satisfied.

1.5≦D≦4 (1)

0.5 D≦A≦0.7 D (2)

### First Embodiment

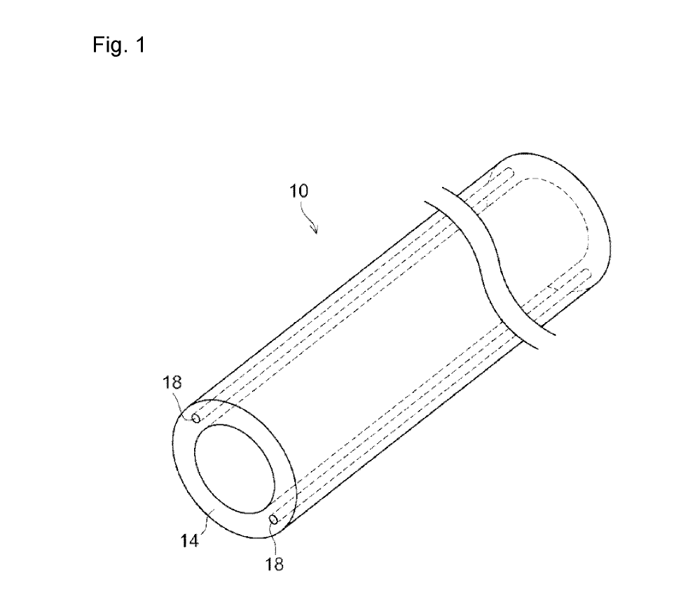

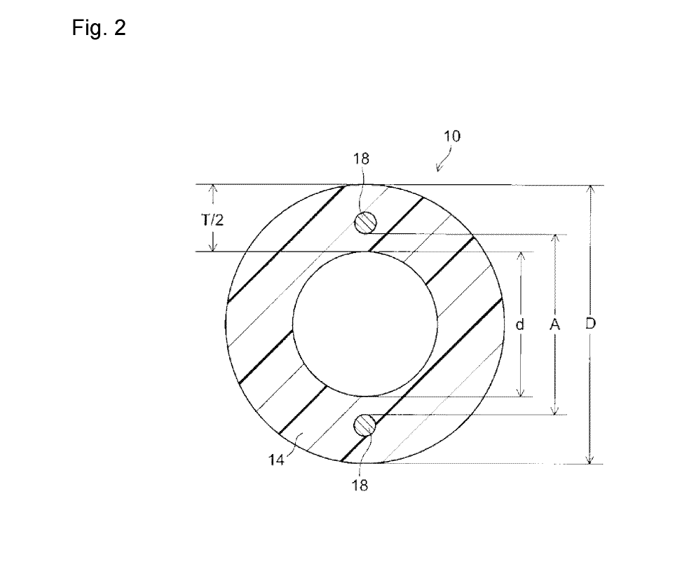

FIG. 1 is a schematic view showing an exemplary structure (first embodiment) of the outer casing according to an embodiment of the invention, and FIG. 2 is a schematic view showing a cross-section perpendicular to the axial direction thereof.

An outer casing 10 according to the embodiment includes a resin tube 14 having a single-layer resin layer formed in a tubular shape, and two metal wires 18 buried in the resin layer of the resin tube 14, in parallel with the axial direction and at positions symmetrical with each other about the axis. The outer diameter D (mm) of the resin tube 14 and the distance A (mm) between the two metal wires 18 satisfy the above described formulae (1) and (2).

In the invention, the “distance A between the two metal wires” means the shortest distance between the metal wires when a cross-section of two parallel metal wires perpendicular to the axial direction is seen as shown in FIG. 2.

Constituent elements are described below.

(Resin Tube)

The resin tube 14 of the outer casing 10 shown in FIG. 1 is made of a single-layer resin layer. An outer diameter D (mm) of the resin tube 14 is from 1.5 to 4 mm. When the outer diameter D of the resin tube 14 is smaller than 1.5 mm, the strength of the outer casing 10 is insufficient, and burying two metal wires 18 in the resin layer in parallel with and at positions symmetrical about the axis of the tube 14 is difficult. Meanwhile, when the outer diameter of the resin tube 14 exceeds 4 mm, routing properties are deteriorated. In view of the above points, the outer diameter of the resin tube 14 needs to be from 1.5 to 4 mm.

The inner diameter d (mm) of the resin tube 14 is preferably determined such that a difference T between the outer diameter D and the inner diameter d satisfies D/2≦T≦5 D/6.

When a control cable is manufactured by inserting an inner wire inside the resin tube 14 made of the single-layer resin layer as the embodiment, the resin layer needs to have favorable slidability, because the resin layer directly contacts the inner wire. For the outer casing 10 according to the embodiment, therefore, a crystalline resin is preferably used as the resin that forms the resin tube 14. Specifically, high density polyethylene, polypropylene, polymethylpentene, polyoxymethylene, nylon 6, nylon 66, polybutylene terephthalate (PBT), polyethylene terephthalate (PET), or the like may be used. Among these, high density polyethylene, polypropylene, polyoxymethylene, nylon 6, and nylon 66 are preferable as having favorable moldability and durability. High density polyethylene, polyoxymethylene, nylon 6, and nylon 66 are the most preferable as having favorable silidability, and no grease is needed to be put in a through hole of the outer casing for the purpose of improvement of slidability.

When the crystalline resin that forms the resin tube 14 is softer, wire routing of the cable becomes easier because the flexibility of the cable is improved. However, if the crystalline resin is too soft, the metal wires 18 protrude more easily from the end face when the cable is bent. The storage modulus of the crystalline resin included in the resin tube 14, therefore, is preferably a little higher, from 800 to 3,000 MPa, and more preferably from 950 to 3,000 MPa. Although such a highly rigid resin is used, since the outer casing 10 of the invention is thin, it is flexible, and there is no problem for wire routing.

Example of resins having the storage modulus within the above-mentioned range includes polypropylene, polyoxymethylene, polybutylene terephthalate, polyethylene terephthalate, and nylons. Polypropylene with a slidability improving material, such as silicone resin, added thereto may also be used favorably. Nylon 6 and nylon 66 are highly preferable as having high adhesiveness to metals.

Soft polyvinyl chloride or a soft resin called a thermoplastic elastomer may also be applicable to form the resin tube 14. In this case, however, the metal wires 18 easily slip from the resin when the outer casing 10 is bent, and the end of the metal wires 18 may possibly protrude from the resin layer. The metal wires 18, therefore, are preferably subjected to primer treatment in advance to increase adhesiveness to resins.

(Metal Wire)

The two metal wires 18 are buried, in the resin layer of the resin tube 14, in parallel with the axial direction and at the positions symmetrical with each other about the axis of the resin tube 14.

The metal wires 18 being “in parallel with the axial direction of the resin tube” in regard to the metal wires 18 does not mean that when the outer casing 10 is configured linearly, an angle between the metal wires 18 is limited to 0°, and the angle may change intermittently be within 10°. In addition, “at the positions symmetrical about the axis of the resin tube” means that, when seen as the cross-section perpendicular to the axis as shown in FIG. 2, the axis of the resin tube 14 and the axes of the two metal wires 18 are not all necessarily arranged on a straight line, as long as the angle made by connecting the axis of the resin tube 14 and the axis of individual metal wires 18 is within the range of 180±10°.

The metal wires 18 buried in the resin layer of the resin tube 14 includes hard steel wires, soft steel wires, stainless steel wires, or the like.

A diameter of the metal wire 18 is preferably from about 0.1 to 0.5 mm depending on the outer diameter of the resin tube 14 in view of the flexibility and the strength of the wire.

A stranded wire made by stranding one to five metal wires each having a wire diameter of from 0.05 to 0.2 mm may preferably be used to improve flexibility of the obtained outer casing 10.

In the embodiment, the distance A (mm) between the two metal wires 18 buried in the resin layer satisfies a relationship of 0.5 D≦A≦0.7 D relative to the outer diameter D of the resin tube 14. When the distance A between the two metal wires 18 is within 50% to 70% of the outer diameter D of the resin tube 14, high routing properties are obtained.

The distance A (mm) between the two metal wires 18 preferably satisfies a relationship of A=D−0.6 T relative to the outer diameter D of the resin tube 14 and the difference T between the outer diameter and the inner diameter of the resin tube 14. In addition, the distance A (mm) is required to be within a range from 0.75 to 2.8 mm.

When the distance A between the two metal wires 18 is smaller than 0.75 mm, since the inner diameter d of the resin tube 14 is small and the thickness thereof is also small, burying the metal wires 18 becomes difficult. The wire diameter of the inner wires also has to be small in such a case, whereby the inner wires cannot endure the load to be pulled and the durability thereof is insufficient. Meanwhile, when the distance A between the two metal wires 18 is larger than 2.8 mm, bending toward the plane including the metal wires 18 suddenly becomes difficult, and the routing properties deteriorate. The distance A between the metal wires 18 may vary depending on factors such as the outer diameter D and the inner diameter d of the resin tube 14, or the wire diameter of the metal wires 18. However, from the viewpoint of obtaining superior routing properties and highly reliable durability, the distance A between the metal wires 18 is preferably in a range from 1.0 to 2.8 mm.

The metal wires 18 may be provided with irregularities intermittently in the longitudinal direction of the metal wires 18. The irregularities would enter the resin of the resin layer to suppress slipping movement of the metal wires 18. As a result, protrusion of the metal wires 18 is effectively suppressed even when the outer casing 10 or the control cable is bent.

Such irregularities can be formed, for example, by roll pressing of the metal wires 18.

The metal wires 18 and the resin become a kind of metal fiber reinforcing resin, such that the thermal expansion is halved compared to a case in which the metal wires 18 are not buried, and the compression strength and the tensile strength, particularly at high temperatures, are greatly improved.

When the resin of the resin layer 14 is made of a soft resin, such as soft vinyl chloride or a thermoplastic elastomer, the resin enters the irregularities of the metal wires 18 only weakly, and the metal wires 18 are bent and easily protruded from end terminals of the resin layer. If the resin is shifted from the metal wires 18, a reinforcing effect by the metal wires 18 is easily decreased.

The metal wires 18 may be subjected to easy adhesion treatment to increase the adhesiveness to the resin and restrict the slipping movement of the metal wires 18. The easy adhesion treatment is very effective when the soft resin is used as the resin layer, but is also effective when a hard resin is used. The effect of the easy adhesion treatment may further increase by increasing a surface area of the metal wires 18 by, for example, providing the irregularities in the metal wires 18, using the stranded wires, or the like.

### Second Embodiment

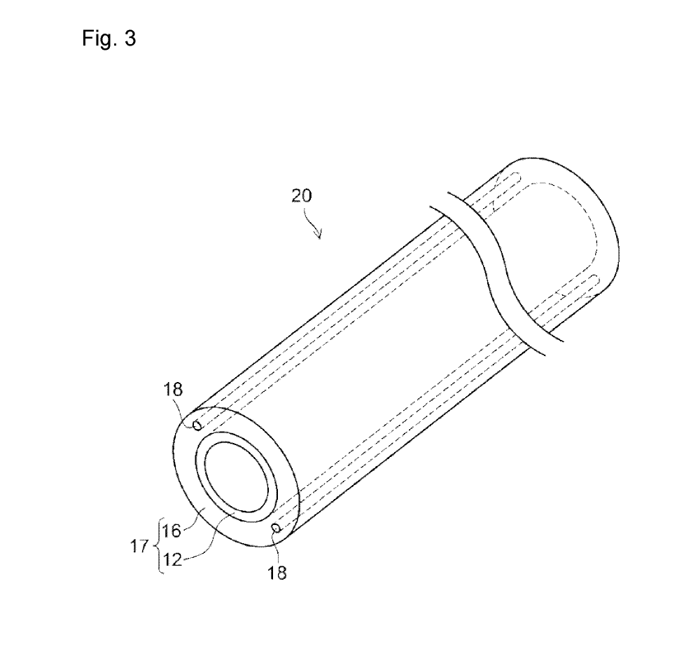

FIG. 3 is a schematic view showing another exemplary structure (second embodiment) of an outer casing according to an embodiment of the invention. In the outer casing 20 according to the present embodiment, a resin tube 17 includes two-layered resin layers 12, 16. An outer tube (outer resin layer) 16 has two metal wires 18 buried therein, and an inner tube (inner resin layer) 12 is layered inside the outer tube 16 and includes a crystalline resin.

In the case that the resin layer of the resin tube 17 has a two-layered structure as in the embodiment, it is also sufficient that the above formulae (1) and (2) are satisfied.

In the embodiment, the “difference between the outer diameter and the inner diameter of the resin tube” means a difference between the outer diameter and the inner diameter of the entire resin tube, that is, the “difference between the outer diameter of the outer tube 16 and the inner diameter of the inner tube 12”.

The structure of the outer casing according to the second embodiment will be described below, but the materials of the metal wires are the same as those of the first embodiment, and the description thereof will not be repeated.

(Inner Tube)

The inner tube 12 (which may also be referred to as a “resin liner” or a “liner”) includes the crystalline resin.

A melting point of the crystalline resin forming the liner 12 is preferably in a range equal to or higher than 120° C. The liner 12 formed with the crystalline resin having the melting point in this range has a superior slidability relative to an inner cable (not shown). In addition, when the resin to form an outer tube 16 is extruded at high temperature around the outer peripheral surface of the liner 12 to cover the liner 12 in manufacturing, the fusing or deforming of the liner 12 is restricted.

For example, even when a high density polyethylene which has a relatively low melting point (melting point of 135° C.) is used as the crystalline resin, the liner 12 is hardly deformed during extrusion molding of the outer tube 16. If a crystalline resin having a higher melting point is used, deformation is further restricted.

An upper limit of the melting point of the crystalline resin included in the liner 12 is preferably about 265° C. Molding is easy if the melting point is not more than 265° C., as the extrusion can be carried out at a relatively low temperature.

If the resin that forms the liner 12 is amorphous resin, even when a very hard resin, such as polycarbonate, is used, or grease is injected in the inner peripheral surface of the liner, the slidability of the liner 12 relative to the inner cable is deteriorated and the function as a control cable largely decreases.

Examples of the crystalline resins to form the liner 12 include nylon 66 (melting point of 260 degrees), nylon 6 (melting point of 220 degrees), polybutylene terephthalate (melting point of 220 degrees), polyoxymethylene (melting point of from 165 to 175 degrees), polymethylpentene (melting point of 230 degrees), polypropylene (melting point of 165 degrees), and a high density polyethylene (melting point of 135 degrees). These resins are preferable because friction coefficients are low and load efficiencies are high. In particular, a high load efficiency may easily be obtained with polybutylene phthalate, polyoxymethylene, or a high density polyethylene.

The thickness of the liner 12 is preferably from 50 to 1,000 μm, and is particularly preferably from 100 to 500 μm, in order to minimize damage caused by heat when the outer tube 16 is extruded to cover the outer peripheral surface of the liner.

(Outer Tube)

The crystalline resin, such as the one described as the single-layer resin tube 14 according to the first embodiment, may be used as the resin to form the outer tube 16 in which the metal wires 18 are buried and which is located at the outer side. In a control cable, the inner cable contacts the inner tube 12, but does not contact the outer tube 16. It is not necessary, therefore, to consider the slidability between the outer tube 16 and the inner cable or to use the crystalline resin.

Meanwhile, the resin forming the outer tube 16 having the storage modulus of equal to or smaller than 3,000 MPa is preferable, as protrusion of the metal wires due to bending of the cable is restricted as in the resin tube of the first embodiment. The resin having the storage modulus of not more than 2,500 MPa, and more particularly not more than 1,500 MPa, is preferable, as such resin is bent particularly easily.

The resin included in the outer tube 16 is preferably the resin having a melting point or a glass transition point of not more than 210° C., and more preferably not more than 180° C. If the resin having the melting point or the glass transition point (in the case of amorphous resin) of not more than 210° C., the liner 12 is hardly damaged when the resin is extruded onto the outer peripheral surface of the liner 12 to cover the liner 12.

A difference between the melting point (T1) of the crystalline resin that forms the liner 12 and the melting point or the glass transition point (T2) of the resin that forms the outer tube 16, i.e., ΔT=(T1−T2), is preferably in a range from −50 to +130° C. The manufacture is easier as ΔT increases positively.

Examples of resins that can be applied to form the outer tube 16 include soft vinyl chloride, a polyethylene-based resin, a polypropylene-based resin, polyoxymethylene, or thermoplastic elastomers, such as a styrene-based thermoplastic elastomer, a thermoplastic urethane elastomer, an ester-based thermoplastic elastomer, or a polyethylene-based thermoplastic elastomer, or an olefin-based thermoplastic elastomer in which EPDM (ethylene-propylene-diene rubber) or ethylene propylene copolymer is dispersed may also be used.

Examples of polyethylene-based resins includes high density polyethylene, linear chain low density polyethylene, low density polyethylene, and polyethylene-based thermoplastic elastomer. The most preferable resin is the high density polyethylene. High density polyethylene has a density of from 0.941 to 0.970 and is a resin with high crystallinity among polyethylenes, and thus has excellent heat resistance and chemical resistance.

Examples of polypropylene-based resins include a block or random copolymer polypropylene, in addition to a homo polypropylene.

Among these resins, the soft vinyl chloride or the thermoplastic elastomer is preferable, as such resins are soft and thus routing properties may be improved by using the resin.

When a crystalline resin such as a polyethylene-based resin, a polypropylene-based resin, or polyoxymethylene is used as the outer tube 16, the outer tube 16 fits closely (bonds tightly) to the inner tube 12, as the outer tube 16 has a large mold shrinkage factor. As a result, slipping movement between the inner tube 12 and the outer tube 16 is restricted even when the inner tube 12 and the outer tube 16 are not bonded with each other.

The inner tube 12 and the outer tube 16 can be strongly bonded with each other by easy adhesion treatment, which is described below, such as plasma irradiation or primer treatment, on the outer peripheral surface of the inner tube 12, regardless of the material of the outer tube 16.

The thickness of the outer tube 16 is preferably from 0.2 to 1.6 mm, and more preferably from 0.3 to 1.5 mm, from the viewpoints of the strength of the control cable, and in view of the relationship to the diameter of the metal wire 18 and to thermal damage to the liner.

<Method of Manufacturing Outer Casing for Control Cable>

A method of manufacturing the outer casing 10 according to the embodiment is not particularly limited.

For example, when the outer casing including the resin tube having the two-layered structure as shown in FIG. 3 is manufactured, the inner tube 12 made of the crystalline resin may be inserted into the outer tube 16 with the two metal wires 18 buried therein. Preferably, after the inner tube 12 is formed, the outer tube (outer resin layer) 16 is extruded and molded on the outer periphery of the inner tube 12, so as to cover the inner tube 12 with the outer tube 16 in which the plural metal wires 18 are buried in the outer resin layer 16 in parallel with the axis and at positions symmetrical with each other about the axis.

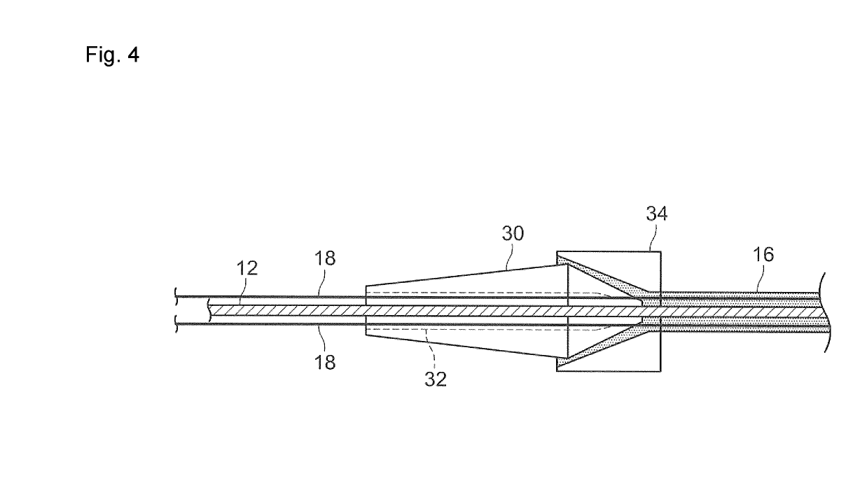

FIG. 4 schematically shows a part of the manufacturing steps of the control cable according to the second embodiment. For example, the resin liner 12 may be manufactured in advance, or two extruders are provided such that one extruder is used to manufacture the resin liner 12, and two metal wires 18 and the liner 12 are inserted into the other extruder from an insertion hole 32 of a nozzle 30 located behind the die 34 of the other extruder. At this time, the two metal wires 18 are inserted in parallel with the axial direction of the liner 12 and at equal intervals in the circumferential direction (i.e., symmetrical about the axis) of the liner 12. The resin liner 12 and the metal wires 18 are introduced into the die 34, and a resin tube (outer resin layer 16) is extruded to cover the outer peripheral surface of the liner 12 while being fed from the die 34. Thus, the two metal wires 18 are buried in the thickness of the resin tube 16 in parallel with the longitudinal direction of the resin tube 16 and at positions approximately symmetrically with each other.

The resin tube, which is formed by covering the outer peripheral surface of the resin liner 12 by the outer resin layer 16 (outer resin) having the two metal wires 18 buried in parallel with the axial direction and at the positions symmetrical with each other, has favorable inner and outer diameter dimensions, and does not need to be passed through an outer diameter adjusting apparatus provided with a vacuum apparatus (a former: an apparatus for controlling the outer diameter by suctioning the outer surface of an extruded tubular body).

When the outer casing is manufactured in the above-described steps, it is sufficient to adjust the outer diameter D (mm) of the outer tube and the distance A (mm) between the two metal wires to satisfy the formulae (1) and (2).

When the outer casing 10 according to the embodiment is manufactured as described above, it is preferable to treat at least one contact surface of a contact surface between the inner tube (liner) 12 and the outer tube 16, or a contact surface between the metal wires 18 and the outer tube 16, with the easy adhesion treatment.

The easy adhesion treatment in the invention may be oxidation treatment, such as corona discharge or plasma irradiation, or primer treatment.

For example, a liner made of high density polyethylene or polyoxymethylene has poor adhesiveness to the polypropylene-based elastomer, and the liner 12 is not adhered to the outer resin layer 16 when the outer peripheral surface of the liner is covered by the soft vinyl chloride. However, if the outer peripheral surface of the liner 12 is is subjected to the corona discharge or the plasma treatment, adhesiveness between the soft vinyl chloride and the liner significantly increases, whereby the inner tube 12 and the outer tube 16 become integrated and a superior adhesiveness is kept against compression.

Adhesiveness of the metal wires and the resin is usually low. For example, if a polypropylene-based elastomer is used for the outer resin layer 16, an obtained outer casing has an excellent flexibility, but the metal wires 18 may slip in the outer resin layer 16 due to repeated bending and thus the metal wires 18 may protrude from the outer resin layer 16.

However, by applying primer to the surface of the metal wires 18, adhesiveness between the resin and the metal greatly increases and protrusion of the metal wires 18 can be prevented effectively regardless of bending.

Exemplary types of the primer includes a resin solution (MAO) of polyolefin treated with polar group, such as maleic anhydride, a copolymer of an epoxy group-containing monomer, such as glycidyl acrylate (GMP), chlorinated polyolefin (CPE), or chlorinated ethylene-vinyl acetate copolymer (CEVA), and further aqueous or solvent dispersion of olefin resin particles (PO emulsion). These primers can improve adhesiveness between resin and metal, or between different types of resins. It is more effective to use the primer with plasma irradiation or corona discharge.

<Control Cable>

The control cable of the invention includes the outer casing according to the invention as described above and an inner cable inserted in the outer casing (inner tube).

The outer periphery of the outer casing of the invention may be covered by a cylindrical protector or foamed body for purposes such as oil proofing, heat resistance, vibration proofing, and hammering noise prevention.

A metal wire may be used as an inner cable, and should be selected in accordance with the required strength or the like.

The metal wire may be coated with resin, such as nylon, for the rustproof purpose.

Grease may be injected into the outer casing to improve the slidability.

The control cable of the invention is not limited to a specific use, and may be used in various uses, such as a sunroof open/close cable, a seat cable, a window open/close cable, a parking brake cable, a trunk opening cable, a fuel opening cable, a bonnet cable, a key lock cable, a heater adjusting cable, an automatic transmission cable, an a throttle cable, or an accelerator cable.

### EXAMPLES

Examples of the invention will be described below, but the invention is not limited to such examples.

First, materials and treatment details used in the examples and comparative examples are described below.

The storage modulus listed in used resins was measured by a dynamic viscoelasticity measuring apparatus (manufactured by TA Instruments) at a temperature increasing speed of 2° C./minute and a frequency of 1 hz in a tension mode.

### (Resin)

Resin PE: HI-ZEX 500H (high density polyethylene, MFR: 0.10, density: 0.958, storage modulus: 1300 MPa, melting point: 132° C., manufactured by PRIME POLYMER).

Resin POM: Iupital F10 (polyoxymethylene, density: 1.41, storage modulus: 2800 MPa, melting point: 160° C., manufactured by Mitsubishi Engineering-Plastics Corporation).

Resin PBT: NOVADURAN 5010Trxa (polybutylene terephthalate, density: 1.27, storage modulus: 2400 MPa, melting point: 220° C., manufactured by Mitsubishi Engineering-Plastics Corporation).

Resin PC: Iupilon E2000 (polycarbonate (amorphous resin)), density: 1.20, storage modulus: 2300 MPa, glass transition point: 150° C., manufactured by Mitsubishi Engineering-Plastics Corporation).

Resin TPO: MILASTOMER M4400B (polypropylene-based thermoplastic elastomer resin, MFR: not more than 1, density: 0.89, storage modulus: 410 MPa, melting point: 150° C., manufactured by Mitsui Chemicals, Inc.).

Resin PP1: Prime Polypro E105GM (MFR: 0.5, density: 0.89, storage modulus: 960 MPa, melting point: 162° C., manufactured by PRIME POLYMER).

Resin PP2: Prime Polypro E150GK (MFR: 0.6, density: 0.90, storage modulus: 900 MPa, melting point: 158° C., manufactured by PRIME POLYMER).

Resin PVC: VINIKA CE85E (soft vinyl chloride (amorphous resin), A hardness: 83, density: 1.44, storage modulus: 300 MPa, glass transition point: 22° C., manufactured by Mitsubishi Chemical Corporation).

(Metal Wire)

Hard steel wire: a heat-treated metal wire having a wire diameter of 0.33 mm.

Stranded wire: a metal wire stranded by three hard steel wires each having a diameter of 0.15 mm at 2 mm pitch.

(Easy Adhesion Treatment)

Plasma irradiation: A material (resin liner) was subject to plasma irradiation at a speed of 100 mm per second by the Real Plasma APG-500 manufactured by KASUGA ELECTRIC WORKS LTD.

Primer: The metal wire was immersed in UNISTOLE R300 (organic solvent solution of acid-modified polypropylene manufactured by Mitsui Chemicals Inc.) for 0.5 minute and dried at 150° C. for two minutes before use.

### Example 1

### Manufacture of Single-Layer Outer Casing Including Metal Wire

Pellets of the resin PP1 were fed into a cross-head type single-screw extruder (manufactured by Japan Steel Works, Ltd.), which has a screw diameter of 30 mm and a ratio of length to diameter (L/D)=30, to extrude the resin in the shape of a tube at a screw temperature of 210° C. Meanwhile, two hard steel wires were introduced into the die from the rear part of the die to be molded by extrusion, in such a manner that the two hard steel wires were buried in the longitudinal direction and at symmetrical positions in the middle portion of the thickness of the resin tube. As a result of this, a single-layer outer casing including metal wires having an outer diameter (D) of 4 mm, an inner diameter (d) of 2 mm, a thickness (T/2) of the resin layer of 1 mm, and a distance (A) between the metal wires of 2.8 mm was obtained.

### Examples 2 to 5, 7, 8, and 10, and Comparative Examples 1 to 3

The outer casing was manufactured in the same manner as in Example 1 except that the materials and the measurements listed in Tables 1 and 2 below replace those of Example 1.

### Example 9

### Manufacture of Two-Layered Outer Casing Including Metal Wire

Pellets of the resin PE were fed into a single-screw extruder (manufactured by SOKEN) having a screw diameter of 30 mm, a length-diameter ratio (L/D)=22 to sequentially extrude tubular molded products each having a 1.3 mm inner diameter and a 1.9 mm outer diameter at a screw temperature of 200° C., whereby the resin liner (inner tube) was obtained.

The resin liner previously manufactured as described above was inserted into a cross-head type single-screw extruder (manufactured by the Japan Steel Works, Ltd.), which has a screw diameter of 30 mm and the ratio of length to diameter (L/D)=30, from the rear part of the die.

Meanwhile, pellets of the resin POM were fed into the single-screw extruder. In the step of forming an outer resin layer by covering the outer periphery of the resin liner with the resin POM at a screw temperature of 210° C., two hard steel wires were introduced into the die to be molded by extrusion in such a manner that the two hard steel wires were buried in the longitudinal direction and in symmetrical positions in the middle portion of the thickness of the outer resin layer (the distance between the metal wires was 2.0 mm). As a result of this, a two-layered outer casing with the metal wires having an outer diameter (D) of 3 mm, an inner diameter (d) of 1.3 mm, and a distance (A) between the metal wires of 2 mm was obtained.

### Examples 11 to 14

The outer casing was manufactured in the same manner as in Example 9 except that the materials and the measurements listed in Table 2 below replace those of Example 1.

[Evaluation]

An inner cable (SWRH62A manufactured by UNIFLEX CO., LTD., diameter: 1.5 mm) was inserted into the obtained outer casing to produce a control cable.

The outer casing and the control cable were evaluated as described below.

(Stroke Loss)

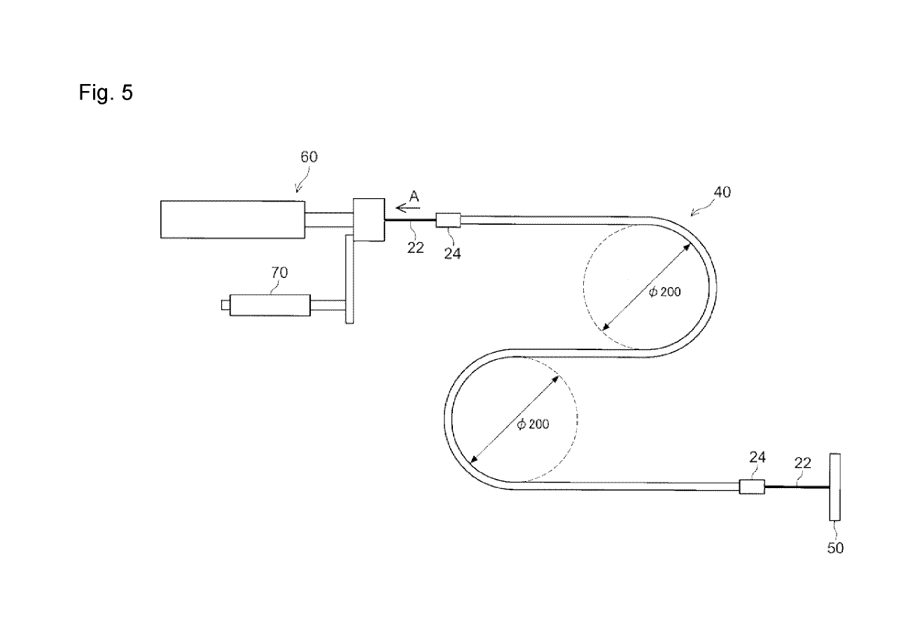

FIG. 5 is a schematic view for explaining how stroke loss is measured. A control cable 40 having a length of 1.5 m was routed in a reverse S-shape having a diameter of 200 mm, as shown in FIG. 5. Metal fittings 24 fitted to both ends of the outer casing were fixed, and one end of the inner cable 22 was fixed to the fitting member 50. In this state, the other end of the inner cable 22 was held by a tensile testing machine 60, and pulled in the direction of arrow A at 80° C. and with a force of 98 N, and “tensile length” of the inner cable was measured by a displacement gauge 70 to obtain a stroke loss value.

(Load Efficiency)

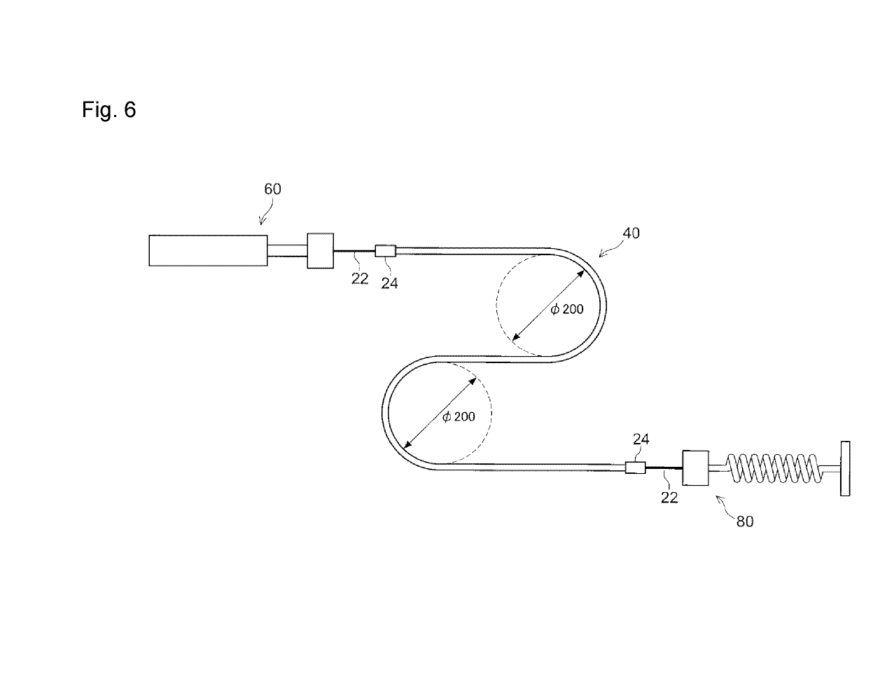

FIG. 6 is a schematic view for explaining how the load efficiency is measured. A control cable having a length of 1.5 m was routed in an R shape having a diameter of 200 mm, and the metal fittings 24 fitted to both ends of the outer casing were fixed. A load meter 80 was attached to one terminal end of the inner cable 22, and the other terminal end of the inner cable 22 was pulled with a force of 98 N at room temperature by the tensile testing machine 60 to measure a load transmitted to the terminal end side. As a result of this, load efficiency was obtained. It is determined that when this ratio increases, the efficiency becomes higher.

(Thermal Expansion)

After an outer casing having a length of 1,000 mm was left for three hours in an 80° C. atmosphere, a length (L1) was obtained. A difference L1−L0 between the length (L1) and a length (L0) measured at room temperature was measured.

(Routing Load)

A terminal end of an outer casing having a length of 300 mm was fixed in parallel with a plane including the two metal wires, and a load was applied to the tip end. When the product was bent about 200 mm in the vertical direction, the load (g) was measured.

(Protrusion of Metal Wire)

After a control cable having a length of 150 mm was bent at R50, a protruded measurement of the metal wire at the terminal end of the outer casing was measured.

(Weight)

A weight of the outer casing for 1 m was measured.

TABLE 1

| | | COMPAR- | COMPAR- | | | | | | |
|---|---|---|---|---|---|---|---|---|---|
| | | ATIVE | ATIVE | | | | | | |
| | | EXAM- | EXAM- | EXAM- | EXAM- | EXAM- | EXAM- | EXAM- | EXAM- |
| | | PLE 1 | PLE 2 | PLE 1 | PLE 2 | PLE 3 | PLE 4 | PLE 5 | PLE 7 |
| Outer diameter of product D (mm) | | 6 | 5 | 4 | 3.5 | 3 | 2 | 1.5 | 3 |
| Inner diameter of product d (mm) | | 2 | 2 | 2 | 1.5 | 1.3 | 0.5 | 0.4 | 1.3 |
| Distance between metal wires A (mm) | | 3.6 | 3.2 | 2.8 | 2.3 | 2.0 | 1.1 | 0.85 | 2 |
| Liner resin | Type | — | — | — | — | — | — | — | — |
| Outer resin | Type | PP1 | PP1 | PP1 | PP1 | PP1 | PP1 | PP1 | PP2 |
| | Storage modulus (MPa) | 960 | 960 | 960 | 960 | 960 | 960 | 960 | 900 |

| | | | | | | | | |
|---|---|---|---|---|---|---|---|---|
| Easy adhesion treatment | — | — | — | — | — | — | — | — |
| Thermal expansion (mm) | 1.8 | 1.8 | 1.8 | 1.8 | 1.8 | 1.9 | 1.9 | 1.9 |
| Routing load (g) | 400 | 300 | 140 | 80 | 65 | 40 | 30 | 40 |
| Stroke loss (mm) | 3.7 | 3.9 | 3.9 | 3.9 | 4.0 | 4.1 | 4.2 | 4.2 |
| Load efficiency (%) | 51 | 51 | 52 | 52 | 52 | 53 | 54 | 51 |
| Protrusion of metal wire (mm) | 2 | 1.5 | 1 | 1 | 1 | 1 | 1 | 2 |
| Weight (g/m) | 23.1 | 15.4 | 10.1 | 7.5 | 5.8 | 2.8 | 2.0 | 5.8 |
| Remarks | | | | | | | | |

TABLE 2

| | | | | | | | | | COMPAR- |
|---|---|---|---|---|---|---|---|---|---|
| | | | | | | | | | ATIVE |
| | | EXAM- | EXAM- | EXAM- | EXAM- | EXAM- | EXAM- | EXAM- | EXAM- |
| | | PLE 8 | PLE 9 | PLE 10 | PLE 11 | PLE 12 | PLE 13 | PLE 14 | PLE 3 |
| Outer diameter of product D (mm) | | 3 | 3 | 3 | 3 | 3 | 3 | 3 | 3 |
| Inner diameter of product d (mm) | | 1.3 | 1.3 | 1.3 | 1.3 | 1.3 | 1.3 | 1.3 | 1.3 |
| Distance between metal wires A (mm) | | 2 | 2 | 2 | 2 | 2 | 2 | 2 | — |
| Liner resin | Type | — | PE | — | PE | PE | PE | PE | PE |
| Outer resin | Type | POM | POM | PBT | PBT | PP1 | TPO | PVC | PP1 |
| | Storage modulus (MPa) | 2800 | 2800 | 2400 | 2400 | 960 | 410 | 300 | 960 |

| | | | | | | | | |
|---|---|---|---|---|---|---|---|---|
| Easy adhesion treatment | — | — | — | — | — | Primer to | Primer to | — |
| | | | | | | metal wires | metal wires | |
| Thermal expansion (mm) | 1.7 | 1.7 | 1.7 | 1.7 | 1.8 | 1.9 | 2.0 | 1.7 |
| Routing load (g) | 60 | 56 | 60 | 54 | 45 | 30 | 30 | 50 |
| Stroke loss (mm) | 3.8 | 3.8 | 3.8 | 3.8 | 4.0 | 4.1 | 4.2 | 3.8 |
| Load efficiency (%) | 60 | 65 | 57 | 65 | 65 | 65 | 65 | 65 |
| Protrusion of metal wire (mm) | 0 | 0 | 0 | 0 | 1 | 0 | 0 | — |
| Weight (g/m) | 7.8 | 7.5 | 7.3 | 7.0 | 5.9 | 5.9 | 7.7 | 23.0 |
| Remarks | | | | | | | | Flat steel |
| | | | | | | | | wire winding |
| | | | | | | | | Heavy |

(Relationship Between Routing Load and Deflection Amount)

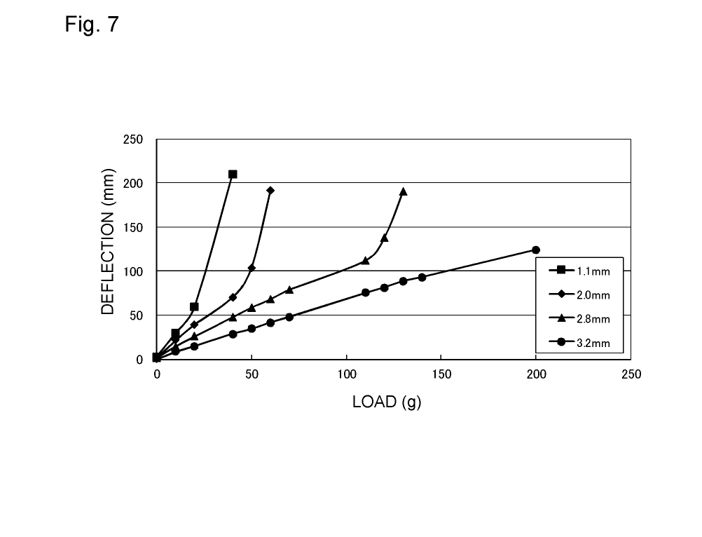

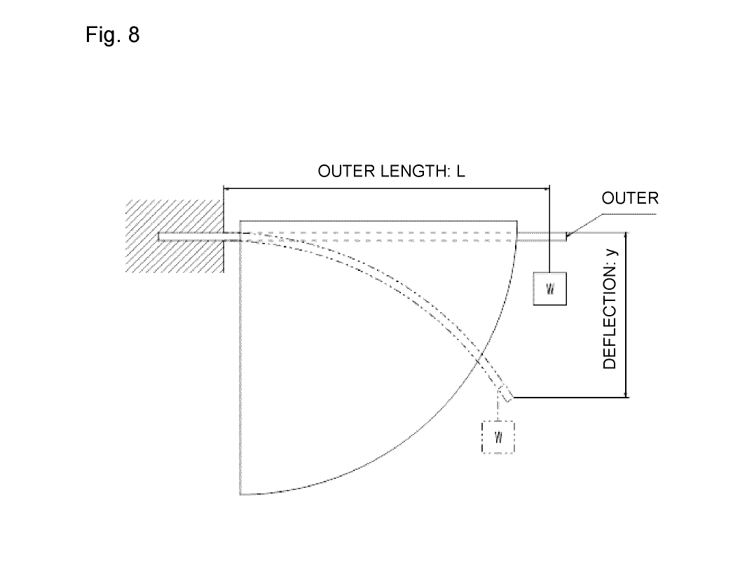

FIG. 7 is a line graph showing a relationship between load and deflection amount of Examples 1, 3, 4 and Comparative Example 2 by measuring the routing load of the outer casing in accordance with the schematic view shown in FIG. 8. The lengths showing the respective kinds of plots in FIG. 7 indicate the distance between the metal wires in the outer casing in each example. Specifically, as shown in FIG. 8, the outer casing was horizontally supported at 300 mm from one end of the outer casing. The outer casing was supported in such a manner that the plane including the two metal wires was arranged vertically. A load (W) was applied to the one end of the outer casing to measure a deflection amount.

When the distance between the metal wires is within the range of the invention (1.1 mm in Example 4, 2.0 mm in Example 3, and 2.8 mm in Example 1), the deflection increases linearly according to the increase of the load. The deflection sharply increases at a point where the deflection exceeds a certain load. Meanwhile, when the distance between the metal wires is beyond the range of the invention (3.2 mm in Comparative Example 2), it is apparent that a load-to-deflection line remains approximately linearly and no inflection point exists. This is presumably because, when the outer casing of the invention is considered to be a kind of metal wire reinforcing resin, the moment of inertia of area decreases as the distance between the metal wires is smaller, and when the distance becomes equal to or smaller than a certain value, the moment of inertia of area decreases exponentially.

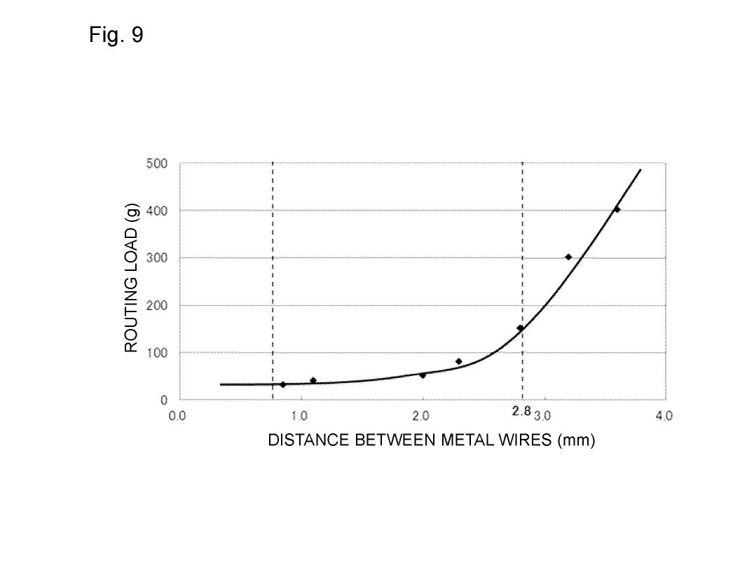

FIG. 9 is a graph plotting the routing load of the outer casing relative to the distance between the metal wires obtained from Examples and Comparative Example in FIG. 7. It is apparent that the inflection point exists at the distance between the metal wires of 2.8 mm and, beyond that, the routing load largely increases.

The disclosure of Japanese Patent Application No. 2013-177002 is incorporated herein by reference in its entirety.

All publications, patents, patent applications, and technical standards mentioned in this description are incorporated herein by reference to the same extent as if each individual publication, patents, patent application, or technical standard was specifically and individually indicated to be incorporated by reference.

1. An outer casing for a control cable, the outer casing comprising:
a resin tube, which has a tubular resin layer; and
two metal wires, which are buried in the resin layer of the resin tube, in parallel with an axial direction of, and at positions symmetrical with each other about an axis of, the resin tube, wherein, assuming that an outer diameter of the resin tube is D (mm) and a distance between the two metal wires is A (mm), the following formulae (1) and (2) are satisfied:
1.5≦D≦4 (1)
0.5 D≦A≦0.7 D (2).

2. The outer casing for a control cable according to claim 1, wherein the resin layer of the resin tube includes a crystalline resin.

3. The outer casing for a control cable according to claim 2, wherein a storage modulus of the crystalline resin is from 950 to 3,000 MPa.

4. The outer casing for a control cable according to claim 1, wherein the resin tube comprises an outer tube, which includes the two metal wires buried therein, and an inner tube, which is layered inside of the outer tube and includes a crystalline resin.

5. The outer casing for a control cable according to claim 4, wherein the outer tube includes a thermoplastic elastomer or soft vinyl chloride resin.

6. A control cable, comprising:
the outer casing for a control cable according to claim 1; and
an inner cable inserted into the outer casing for a control cable.

7. The outer casing for a control cable according to claim 1, wherein the distance A between the two metal wires satisfies a relationship of A=D−0.6 T relative to the outer diameter D of the resin tube and a difference T between the outer diameter and the inner diameter of the resin tube, and the distance A is within a range of from 0.75 to 2.8 mm.

8. The outer casing for a control cable according to claim 4, wherein the distance A between the two metal wires satisfies a relationship of A=D−0.6 T relative to the outer diameter D of the resin tube and a difference T between the outer diameter and the inner diameter of the resin tube, and the distance A is within a range of from 0.75 to 2.8 mm.

9. A control cable, comprising:
the outer casing for a control cable according to claim 2; and
an inner cable inserted into the outer casing for a control cable.

10. A control cable, comprising:
the outer casing for a control cable according to claim 3; and
an inner cable inserted into the outer casing for a control cable.

11. A control cable, comprising:
the outer casing for a control cable according to claim 4; and
an inner cable inserted into the outer casing for a control cable.

12. A control cable, comprising:
the outer casing for a control cable according to claim 5; and
an inner cable inserted into the outer casing for a control cable.

13. A control cable, comprising:
the outer casing for a control cable according to claim 7; and
an inner cable inserted into the outer casing for a control cable.

14. A control cable, comprising:
the outer casing for a control cable according to claim 8; and
an inner cable inserted into the outer casing for a control cable.
